(19) United States
(12) Patent Application Publication
(10) Pub. No.: US 2018/0354462 A1
(43) Pub. Date: Dec. 13, 2018

(54) WINDSHIELD MOUNTED SENSOR FARM SYSTEM INCLUDING USB INTERFACE FOR POWERING ACCESSORIES AND DATA TRANSFER

(71) Applicant: GM Global Technology Operations LLC, Detroit, MI (US)

(72) Inventors: Venkata Vinod PASUMARTHI, Sterling Heights, MI (US); Urvish Zaveri, Sterling Heights, MI (US); Jeffrey A. Roberts, St. Clair Shores, MI (US); Stefan F. Lipski, Bruce Township, MI (US)

(21) Appl. No.: 15/616,962

(22) Filed: Jun. 8, 2017

(51) Int. Cl. B60S 1/08; G06F 1/16; G06F 1/26

(52) U.S. Cl. CPC B60S 1/0818; G06F 1/1637; B60S 1/0888; B60S 1/0874; G06F 1/266

(57) ABSTRACT

A sensor farm assembly is provided that includes a plate, a bracket, and a universal serial bus. The plate is configured to be mounted to an interior side of a windshield of a vehicle. The bracket is connected to the plate. The universal serial bus receiving module configured to be connected to the bracket. The universal serial bus receiving module includes a processing module and a universal serial bus receiver. The processing module is configured to receive power from a power source, where the power source is separate from the sensor farm assembly. The universal serial bus receiver is configured to receive a universal serial bus connector of a universal serial bus cable or an accessory device and provide power from the processing module either directly to the accessory device or via the universal serial bus cable.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vehicle systems for powering and transferring data to and from accessories.

Dashboard and windshield mounted cameras are becoming prevalent for various purposes including insurance related purposes, such as in ride share vehicles. Customers of vehicle manufacturers tend to prefer aftermarket cameras rather than an in-vehicle installed camera provided as a vehicle manufacturer installed option. This is because aftermarket cameras are typically cheaper, easier to upgrade and/or replace, and can be selected by a customer from numerous different available cameras that are available on the market.

### SUMMARY

A sensor farm assembly is provided that includes a plate, a bracket, and a universal serial bus. The plate is configured to be mounted to an interior side of a windshield of a vehicle. The bracket is connected to the plate. The universal serial bus receiving module configured to be connected to the bracket. The universal serial bus receiving module includes a processing module and a universal serial bus receiver. The processing module is configured to receive power from a power source, where the power source is separate from the sensor farm assembly. The universal serial bus receiver is configured to receive a universal serial bus connector of a universal serial bus cable or an accessory device and provide power from the processing module either directly to the accessory device or via the universal serial bus cable.

In other features, a method of operating a vehicle system. The vehicle system includes a sensor farm assembly configured to mount to an interior side of a windshield. The sensor farm assembly includes a universal serial bus receiving module. The universal serial bus receiving module includes a processing module and a universal serial bus receiver. The method includes: receiving power from a power source at the processing module of the universal serial bus receiving module, where the power source is separate from the sensor farm assembly; supplying power from the processing module to the universal serial bus receiver; and supplying power from the universal serial bus receiver either directly to an accessory device or indirectly via a universal serial bus cable to the accessory device. The universal serial bus receiver is configured to connect to the universal serial bus cable or the accessory device.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example of a vehicle system including a universal serial bus (USB) receiving module incorporated in a sensor farm assembly of a vehicle in accordance with an embodiment of the present disclosure;

FIG. 2 is a perspective view of an example of a sensor farm assembly, a rear view mirror assembly and a portion of an overhead console in accordance with an embodiment of the present disclosure;

FIG. 3 is a perspective view illustrating examples of components within the sensor farm assembly of FIG. 2 in accordance with an embodiment of the present disclosure;

FIG. 4 is another perspective view illustrating examples of the components within the sensor farm assembly of FIG. 2 in accordance with an embodiment of the present disclosure;

FIG. 5 is a side cross-sectional view of the sensor farm assembly of FIG. 2 at a plane extending longitudinally along the vehicle and to the right of a longitudinal centerline of the vehicle near a right side wall of a sensor farm assembly cover in accordance with an embodiment of the present disclosure;

FIG. 6 is another cross-sectional view of the sensor farm assembly of FIG. 2 at a plane extending laterally across an upper portion of the sensor farm assembly near the overhead console and in accordance with an embodiment of the present disclosure;

FIG. 7 is a cross-section view of a portion of the sensor farm assembly of FIG. 2 illustrating the USB receiving module and an example USB drive in accordance with an embodiment of the present disclosure;

FIG. 8 is a perspective cross-section view of a portion of the sensor farm assembly of FIG. 2 illustrating the USB receiving module in accordance with an embodiment of the present disclosure;

FIG. 9 is a top view of an interior of the sensor farm assembly of FIG. 2 in accordance with an embodiment of the present disclosure;

FIG. 10 is a bottom view of the interior of the sensor farm assembly of FIG. 2 in accordance with an embodiment of the present disclosure; and

FIG. 11 is a side perspective view of an interior of a vehicle illustrating a vision interference requirement in accordance with an embodiment of the present disclosure;

FIG. 12 is a functional block diagram of an accessory device connected to the sensor farm assembly of FIG. 1 via a cable and in accordance with an embodiment of the present disclosure; and

FIG. 13 illustrates an example USB method in accordance with an embodiment of the present disclosure.

In the drawings, reference numbers may be reused to identify similar and/or identical elements.

### DETAILED DESCRIPTION

Dashboard and windshield mounted cameras are powered via cables, which extend from the cameras to 12 volt (V) power supply receptacles (or cigarette lighter receptacles) located on a center console. The cables tend to extend over displays, controls and interfaces located in a dashboard and/or center console, such as the displays, controls and/or interfaces associated with a stereo, an infotainment system, a climate control interface, a navigation system, etc. If the camera is attached to a windshield, the corresponding power cable extends from the windshield down to the center console is in a field-of-view of the vehicle operator. This can cause visual interference with the field-of-view of the vehicle operator and an environment forward of the vehicle and thus prevent the vehicle operator from seeing fully, for example, a traffic light, a traffic sign, an oncoming object, etc.

The examples set forth herein include a USB receiving module incorporated in a sensor farm assembly, which is mounted to an interior upper central portion of a windshield of a vehicle. The USB receiving module may provide power to an accessory device and/or transfer data between a USB control module in the sensor farm assembly and the accessory device. The accessory device may be a camera, a USB drive, and/or other accessory device. The accessory device may be mounted on an interior side of a windshield and connected to the USB receiving module via a USB cable or may be directly plugged into the USB receiving module. The USB receiving module may communicate with vehicle systems, such as an infotainment system, a powertrain system, a collision avoidance system, an autonomous system, etc.

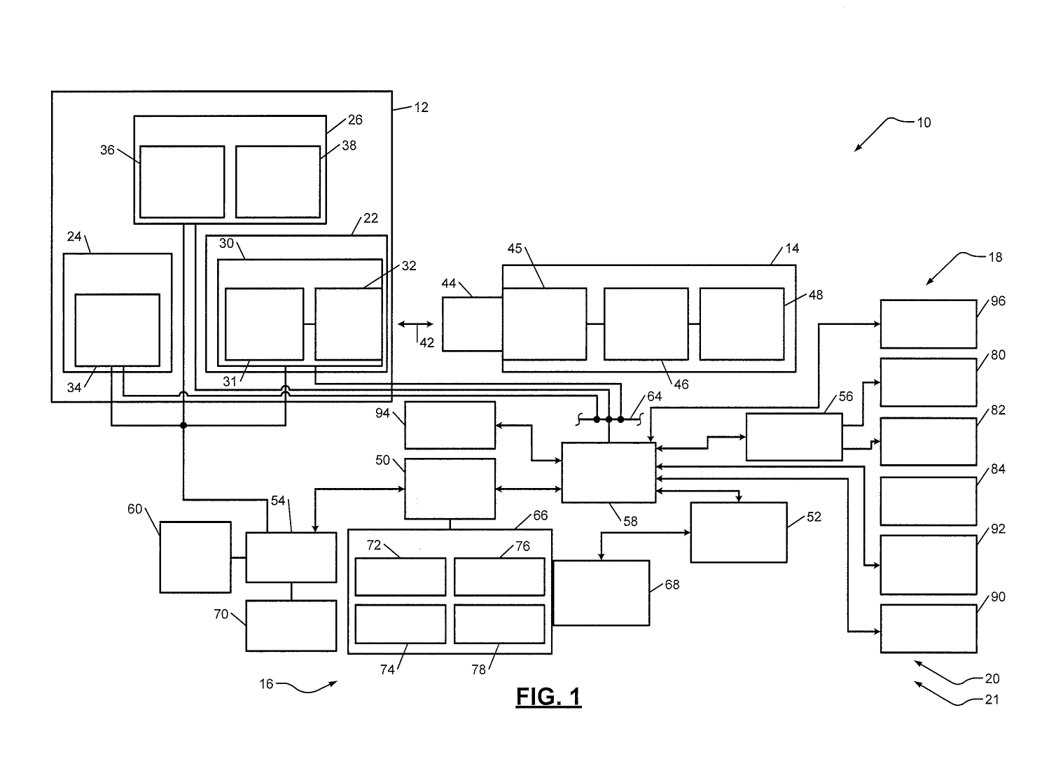

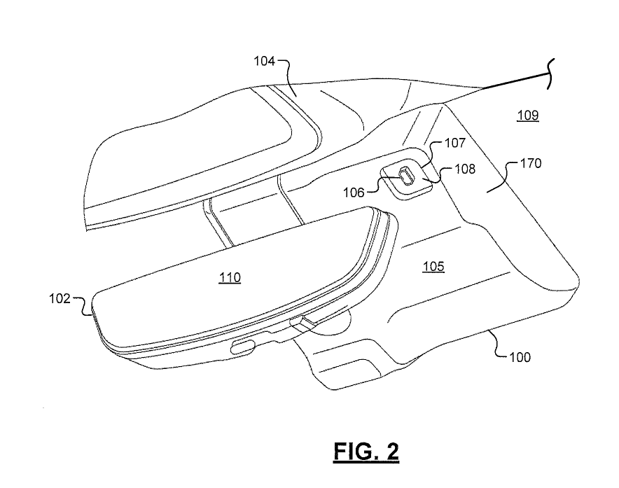

FIG. 1 shows a functional block diagram of an example of a vehicle system 10 including a sensor farm assembly 12, an accessory device 14, a powertrain system 16, an infotainment system 18, a collision avoidance system 20 and an autonomous system 21. The sensor farm assembly 12 may be mounted to an interior upper central portion of a windshield of a vehicle and may be connected to an overhead console, which may be attached to a headliner. This is further illustrated and described at least with respect to FIGS. 2-3 and 11. The sensor farm assembly 12 includes a USB bracket 22, a forward collision avoidance (FCA) camera bracket 24, and a ladder bracket 26. The USB bracket 22 supports a USB receiving module 30 that includes a USB intermediate processing module 31 and a USB receiver 32. The FCA camera bracket 24 supports a FCA camera 34. The ladder bracket 26 supports a humidity/rain sensor 36 and a rear view mirror assembly, which is connected to the ladder bracket 26 via a rearview mirror assembly connector 38. An example of the rearview mirror assembly is shown in FIGS. 2-3 and 11. The humidity/rain sensor 36 may be used for controlling operation of windshield wipers. Activation and/or speed of the windshield wipers may be adjusted based on output of the humidity/rain sensor 36.

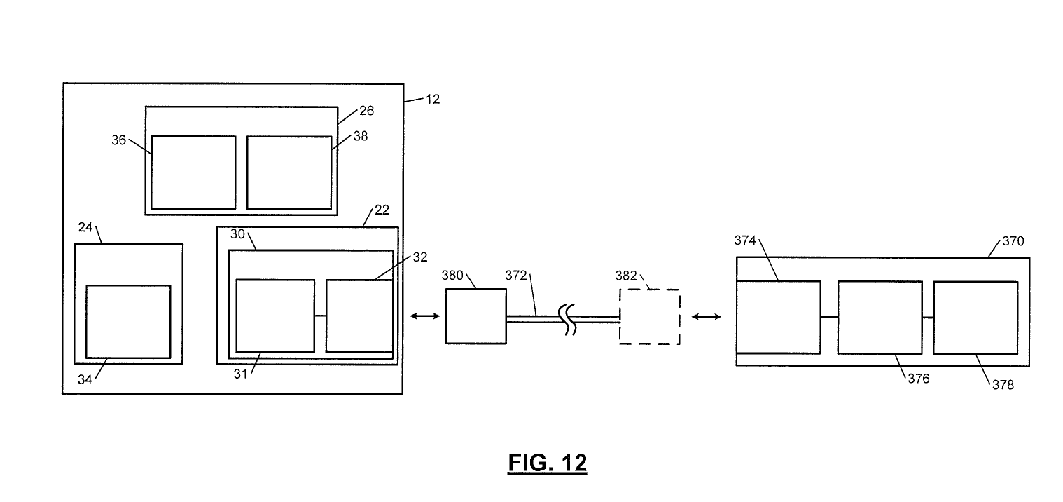

The USB intermediate processing module 31 may transfer power to the accessary device 14 via the USB receiver 32. The USB intermediate processing module 31 may also receive data from and/or transfer data to the accessory device 14 via the USB receiver 32. The USB receiver 32 is configured to connect to a USB cable or directly to an accessory device 14. Arrow 42 represents power supplied from the USB receiver 32 to the accessory device 14. The arrow 42 may also represent communication between the USB receiving module 30 and the accessory device 14. In one embodiment, the arrow 42 represents a USB cable connecting the USB receiver 32 to the accessory device 14. FIG. 12 shows an example of an accessory device being connected to a USB receiving module of a sensor farm assembly via a cable.

The accessory device 14 may be a camera, a flash drive (e.g., a USB drive), a global positioning system device, a navigation system device, an autonomous device, or other accessory device. The accessory device 14 may include a connector (e.g., a USB connector 44 is shown), an interface (e.g., a USB interface 45 is shown), an accessory control module 46 and a memory 48. Although the connector and the interface are shown as being a USB connector and a USB interface, the connector and interface may be of a different type. This may be true, if a cable is used to connect the accessory device 14 to the USB receiver 32. The cable may be used to convert a USB connection to a connection of another type. In one embodiment, the USB receiver may be a type ‘C’ receiver. This allows the connector of the cable and/or the USB connector 44 to be inserted into the USB receiver 32 in one of two positions. The connector of the cable and/or the USB connector 44 may be inserted while in a first position relative to the USB receiver 32 or rotated 180° and inserted while in a second position relative to the USB receiver 32.

The systems 16, 18, 20, 21 include corresponding control modules. The powertrain system 16 includes an engine control module 50, a transmission control module 52, and a hybrid control module 54. The infotainment system 18 includes an infotainment control module 56. The collision avoidance system 20 may include a body control module 58. The autonomous system 22 may include the body control module 58. The USB intermediate processing module 31 may receive power from: a power source in an overhead console, a headliner, and/or in another assembly within the vehicle; the hybrid control module 54; and/or a power source 60. The USB intermediate processing module 31 may communicate with one or more of the control modules 50, 52, 54, 56, 58 via, for example, a controller area network (CAN) bus 64 of a CAN. Although single electrical lines are shown extending between (i) the CAN bus 64 and (ii) devices on the brackets 22, 24, 26, multiple electrical lines may be included. Each device connected to the CAN bus 64 may be connected via two or more lines. Also, shown separately, power may be supplied via the CAN bus to one or more of the devices on the brackets 22, 24, 26.

The powertrain system 16 may include the engine control module 50, the transmission control module 52, the hybrid control module 54, an engine 66, a transmission 68, and electric motor(s) 70. The engine 66 may include a starter motor 72, an ignition system 74, a fuel system 76 and a throttle system 78. The ignition system 74 may include spark plugs, ignition coils and wires, etc. The fuel system 76 may include fuel pumps, fuel rails, fuel injectors, etc. The throttle system 78 may include a throttle plate, a throttle actuator motor, etc.

The infotainment system 18 includes the infotainment control module 56, one or more display(s) 80, speakers 82, and user access modules 84. The user access modules 84 may provide individual audio jacks, stereo (channel and volume) controls, etc. The collision avoidance system 20 may include the engine control module 50, the transmission control module 52, the hybrid control module 54, the body control module 58, sensors and/or cameras (hereinafter sensors/cameras) 90, a brake actuation system 92, etc. The sensors/cameras 90 may include object detection sensors. The brake actuation system 92 may include power brakes for decreasing speed of the vehicle. The transmission control module 52, the hybrid control module 54, and/or the brake actuation system 92 may reduce speed of the vehicle by controlling brake torque on the engine 66, operation of the transmission 68, and/or operation of the electric motor(s). The electric motor(s) 70 may be used to rotate wheels of the vehicle.

Data collected, generated and/or stored in the memory 48 of the accessary device 14 may be uploaded to any of the modules 50, 52, 54, 56. Also, any data stored in and/or accessible to the modules 50, 52, 54, 56 may be downloaded and stored in the memory 48. This allows audio and video files to be uploaded to the infotainment system 18 and viewed within the vehicle and/or downloaded to the accessory device 14 and viewed outside of the vehicle. If the accessory device 14 is a camera, image files may be uploaded from the accessory device 14 to, for example, the infotainment control module 56 or other module of the vehicle and viewed via the infotainment system 18.

Data from the accessory device 14 (e.g., windshield mounted aftermarket camera) may be uploaded to the collision avoidance system 20 and used to prevent a collision. The collision avoidance system 20 collects data and images from the manufacturer installed FCA camera 34 and sensors/cameras 90 within the vehicle and from the accessory device 14. The images from the accessory device 14 may be images of an environment outside and/or forward of the vehicle. The collision avoidance system 20 may then, based on the collected data and/or images, prevent a collision by controlling operation of the engine 66, the transmission 68, and/or a brake actuation system 92. This may include brake torqueing the engine 66, decreasing speed of the engine and/or transmission, applying brake pressure, etc.

The autonomous system 21 may control the engine 66, the transmission 68, a steering system 94 (e.g., a steering wheel, a steering column, a power steering pump, etc.), the brake actuation system 92, etc. to autonomously drive the vehicle. This control may be provided via by the body control module 58 performing as an autonomous control module. The body control module 58 may control the autonomous system 21 based on information and/or data received from the accessory device 14. The body control module 58 may collect images, data and information from various sensors including the sensors/cameras 90. The sensors/cameras 90 may include cameras, audio sensors, accelerometers, radar sensors, etc.

The systems 10, 20, 21 may include a transceiver 21. The transceiver 21 may be located in the sensor farm assembly 12 or separate from the sensor farm assembly 12 as shown. The transceiver 21 may be located in the accessory device 14 and accessed via the USB receiving module 30. The accessory device 14 may operates as a communication device between the USB receiving module 30 and one or more devices internal and/or external to the vehicle. The USB receiving module 30 and/or the body control module 58 may communicate with other vehicles and/or databases external to the vehicle of the vehicle system 10 and aiding in basic vehicle functions. The USB receiving module 30 may communicate with autonomous devices in the vehicle system and/or external to the vehicle system via the transceiver 96 and/or the accessory device 14. The accessory device 14 may be an autonomous device. An autonomous device may be, for example, a sensor, a communication device, or other device enabling autonomous operation of the vehicle. The transceiver 21 may be implemented as a wireless transceiver. The body control module 58 and the systems 20, 21 may operate based on verbal commands received from a vehicle operator via one of the audio sensors. The body control module 58 and the systems 20, 21 may also receive commands from a vehicle operator external from the vehicle via one of the audio sensors.

The body control module 58 and the systems 20, 21 may also receive signals from the radar sensors to detect objects external to the vehicle. The systems 20, 21 may be controlled as described herein based on the signals from the radar sensors. In one embodiment, the accessory device 14 is a radar detector that detects radar signals transmitted from an external device and are received by the accessory device 14. The USB receiving module 30 and/or the body control module 58 may then control operation of the vehicle system 10 and/or systems thereof based on the detected radar signals. The body control module 58 and the systems 20, 21 may receive and interpret images and/or signals from the sensors/cameras 90 to identify characteristics of a road, environmental conditions, vehicle conditions, etc. At least some of this information may be determined based on outputs of the one or more accelerometers.

The accessory device 14, the accessory control module, the USB receiving module 30 and/or the body control module 58 may operate as a vehicle-to-vehicle module that receives and transmits information to other vehicle-to-vehicle modules located in other vehicles. The shred information may be used to control the vehicle system 10 and systems thereof. Various types of information may be shared including environment information (e.g., object data, road data, signal light data, etc.). In another embodiment, the accessory device 14 operates as a audio device and receives audio signals from the USB receiving module 30 and plays out the audio signals. The accessory device 14 may include a speaker (not shown) for playout of the audio signals. For example, if the vehicle is traveling at less than a predetermined speed, then an audio signal may be generated by the body control module 58 and/or the USB intermediate processing module 31 and transmitted to the accessory control module 46. The accessory control module 46 may then playout the audio signal on the speaker to warn a pedestrian that the vehicle is nearby.

FIG. 2 shows an example of a sensor farm assembly 100, a rear view mirror assembly 102 and a portion of an overhead console 104. The sensor farm assembly 100 may replace and/or be configured the same as the sensor farm assembly 12 of FIG. 1. The sensor farm assembly 100 includes a cover 105 that has an access opening 107 in which a USB connector is received by a USB receiver 106 that extends through a USB bracket 108. The USB receiver 106 and USB bracket 108 are examples of the USB receiver 32 and the USB bracket 22 of FIG. 1. In one embodiment, the USB receiver 106 is a port. The second farm assembly 100 is mounted to an interior side of a windshield 109. The rearview mirror assembly 102 is connected to and hangs from the sensor farm assembly 100.

Data from an accessory device (e.g., windshield mounted aftermarket autonomous device) may communicate with the autonomous system 21 and use the data to aid a vehicle operator in driving the vehicle. The autonomous system 21 collects data and images from the FCA camera 34 and sensors/cameras 90 within the vehicle and from the accessory device 14. The images from the accessory device 14 may be images of an environment outside and/or forward of the vehicle. The collision avoidance system 20 may then, based on the collected data and/or images, prevent a collision by controlling operation of the engine 66 and corresponding systems 74, 76, 78, the transmission 68, a brake actuation system 92 and/or the steering system 94. The collision avoidance system 20 may then, based on the collected audio from the operators, prevent a collision by controlling operation of the engine 66 and corresponding systems 74, 76, 78, the transmission 68, the brake actuation system 92, and/or the steering system 94. This may include brake torqueing the engine 66, decreasing speed of the engine and/or transmission, applying brake pressure, steering the vehicle, communicating with other autonomous vehicles or systems internal and/or external to the vehicle, etc.

The overhead console 104 may receive power from the hybrid control module 54 and/or power source 60 and supply power to the sensor farm assembly 100. The sensor farm assembly 100 may supply power to the rear view mirror assembly 102. The rearview mirror assembly 102 may include a mirror 110, a sensor (e.g., a light sensor), a mirror control module, and a mirror actuator. The mirror actuator may tilt the mirror based on a signal received from the sensor.

The USB receiver 106 and access opening 107 are located in an upper right corner of the sensor farm assembly 100 and are on a side of the cover 105 facing the rearview mirror assembly 102. The location of the USB receiver 106 relative to the sensor farm assembly 100, the rearview mirror assembly 102, the overhead console 104 and the windshield 109 allows an accessory device to: (i) be plugged directly into the USB receiver 106 without interfering with the rearview mirror assembly 102; and/or be mounted on the windshield 109 and connected via a short cable to the USB receiver 106 without the cable hanging down and interfering with a field-of-view of a vehicle operator. The rearview mirror assembly 102 may be manually pivoted without contacting the accessory device while being plugged directly into the USB receiver 106.

The location of the USB receiver 106, allows the USB receiver 106 to be easily seen by a vehicle operator while seated in a driver seat of the vehicle. The USB receiver 106 is in an uppermost position of the sensor farm assembly 100 away from the driver to not interfere with the rearview mirror assembly 102 and to allow for a short cable to be connected to an accessory device mounted in an upper area of the windshield 109. This prevents and/or minimizes interference (i) between the cable and the field-of-view, and (ii) between the accessory device and the field-of-view. Although the USB receiver 106 may be disposed in other locations on the cover 105, in some embodiments, the USB receiver 106 is not in the other locations on the cover 105, as these locations are either more difficult to access, to see while seated in the driver seat, and/or do not prevent and/or minimize cable and/or accessory device interference with the field-of-view. For example, the USB receiver 106 is not in the top, left, right, or bottom sides of the cover 105.

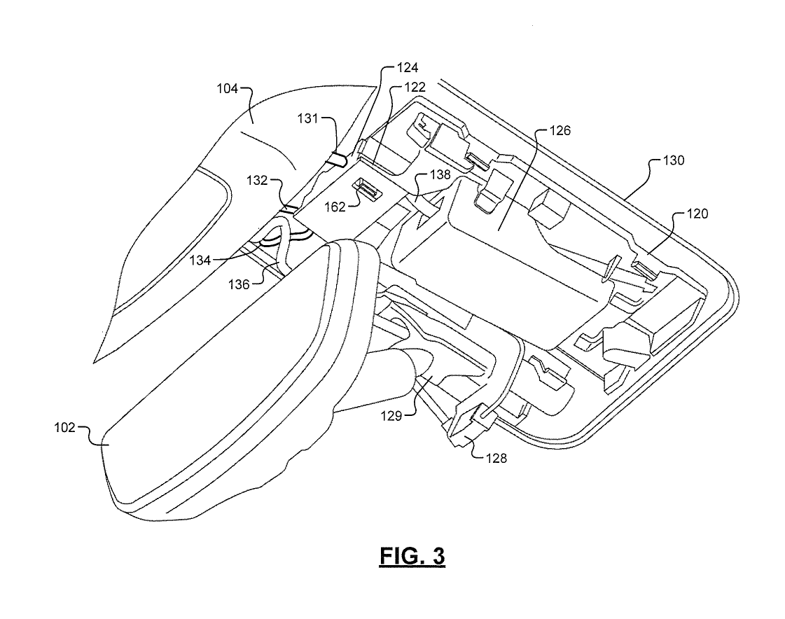

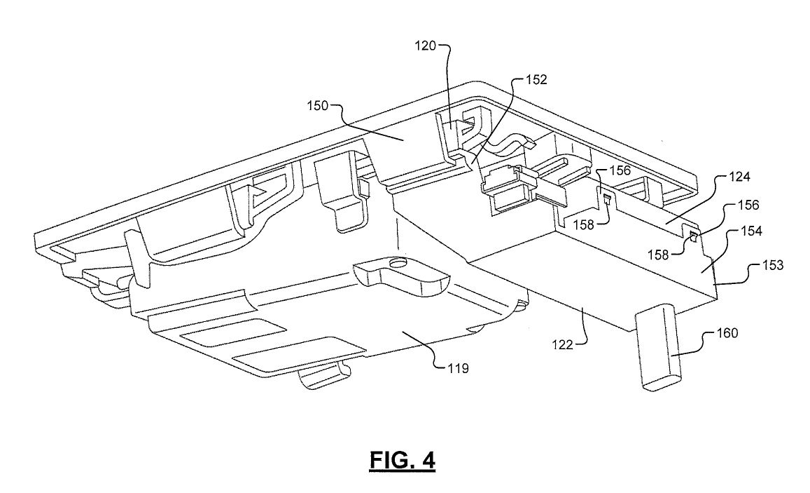

FIGS. 3-4 show examples of components within the sensor farm assembly 100 of FIG. 2. The rearview mirror assembly 102 is shown in FIG. 3 and not in FIG. 4. A FCA camera and mirror component cover 119 is shown in FIG. 4 and not in FIG. 3. The sensor farm assembly 100 includes a FCA camera bracket 120, a USB bracket 122, a USB receiving module 124, a FCA camera housing 126, a mirror connector 128, and a ladder bracket 129. The FCA camera bracket 120 and the ladder bracket 129 are connected to a glass mounting plate 130

The FCA camera bracket 120 supports the USB bracket 122 and thus the USB receiving module 124. Electrical lines 131, 132, 134, 136, 138 transfer power and/or data between (i) the overhead console 104 and (ii) the USB receiving module 124, a FCA camera in the FCA camera housing 126, and the rearview mirror assembly 102. The USB receiving module 124 and/or the FCA camera may receive power via the electrical line 131. The FCA camera may transfer data via electrical line 134. The rear view mirror assembly 102 may receive power via the electrical line 136. The one or more electrical lines supplying power to the USB receiving module 124, the FCA camera, and the rearview mirror assembly 102 and may be connected to (i) a same power source and/or powerline in the overhead console 104, and/or (ii) a same power source and/or powerline in a headliner of the vehicle. The mirror connector 128 may receive power via the electrical line 132.

The USB bracket 122 hangs from the FCA camera bracket 120, which hands from a windshield via the glass mounting plate 130. The FCA camera bracket 120 include ‘L’-shaped flanges (one flange 150 is shown). The USB bracket 122 includes ‘L’-shaped flanges (one flange 152 is shown) that slides on the flanges of the FCA camera bracket 120. The USB bracket 122 has a “cupped” portion 153 and has sides with extensions (e.g., one side 154 with extensions 156 is shown). The USB receiving module 124 is held in the cupped portion 153 and has tabs (two tabs 158 that are received through holes in the extensions 156 are shown). The tabs may snap into the extensions 156. A USB drive 160 is shown as extending through the USB bracket 122 and connecting to the USB receiving module 124 in FIG. 4. The USB receiving module 124 has a USB receiver 162.

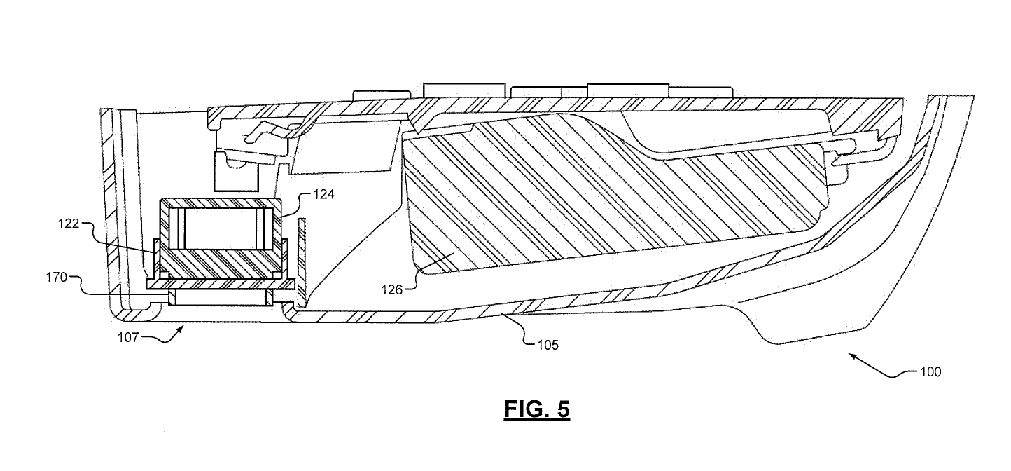

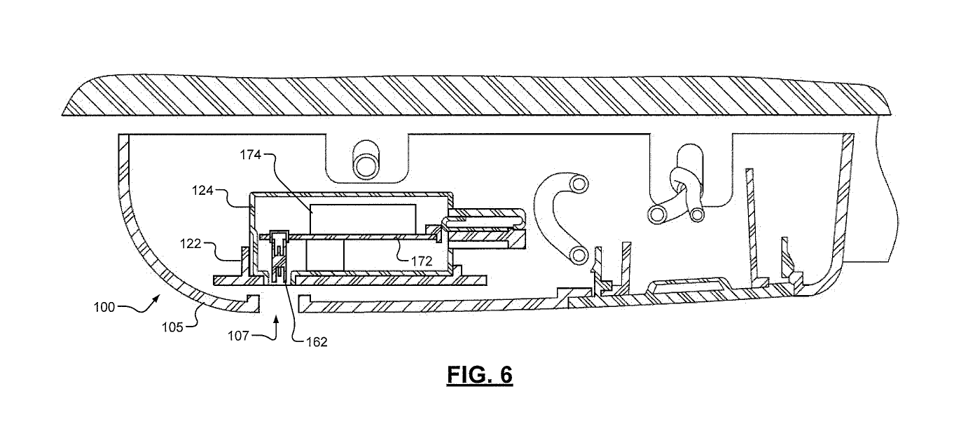

FIGS. 5-6 show side cross-sectional views of the sensor farm assembly 100 of FIG. 2. FIG. 5 shows a cross-section at a plane extending longitudinally along the vehicle and to the right of a longitudinal centerline of the vehicle near a right side wall 170 (shown in FIG. 2) of the sensor farm assembly cover 105. FIG. 6 shows a cross-section at a plane extending laterally across an upper portion of the sensor farm assembly 100 near the overhead console. The sensor farm assembly 100 includes the access opening 107 through which a USB connector of an accessory device is received and connected to the USB receiver 162 of a USB receiving module 124. The USB receiver 162 is connected to a printed circuit board (PCB) 172 on which a USB intermediate processing module 174. The USB receiving module 124 is held on the USB bracket 122. The USB receiver 162 and the USB intermediate processing module 174 are examples of the USB receiver 32 and the USB intermediate processing module 31 of FIG. 1.

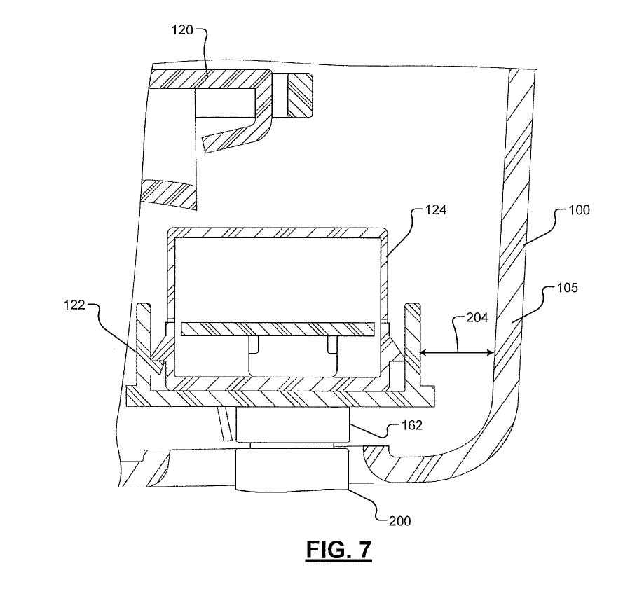

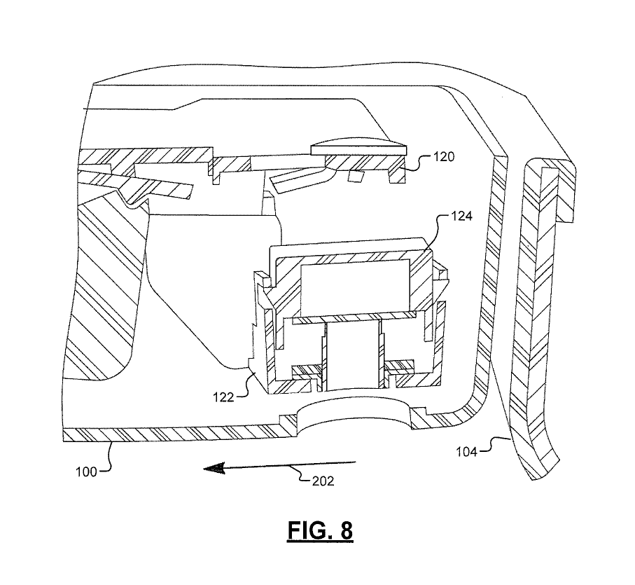

FIGS. 7-8 shows cross-section views of respective portions of the sensor farm assembly 100 of FIG. 2 illustrating the USB receiving module 124 and an example USB drive 200. The sensor farm assembly 100 includes the USB receiving module 124 held on the USB bracket 122, which is supported by the FCA camera bracket 120. The sensor farm assembly 100 is adjacent the overhead console 104. The arrow 202 shown in FIG. 8 points to the front of the vehicle. A predetermined amount of clearance (represented by arrow 204) is provided between the USB bracket 122 and a rear wall 206 of the cover 105 of the sensor farm assembly 100. This clearance is provided for packaging and to prevent interference between (i) the rear wall 206 and (ii) the USB receiving module 124 and the USB bracket 122.

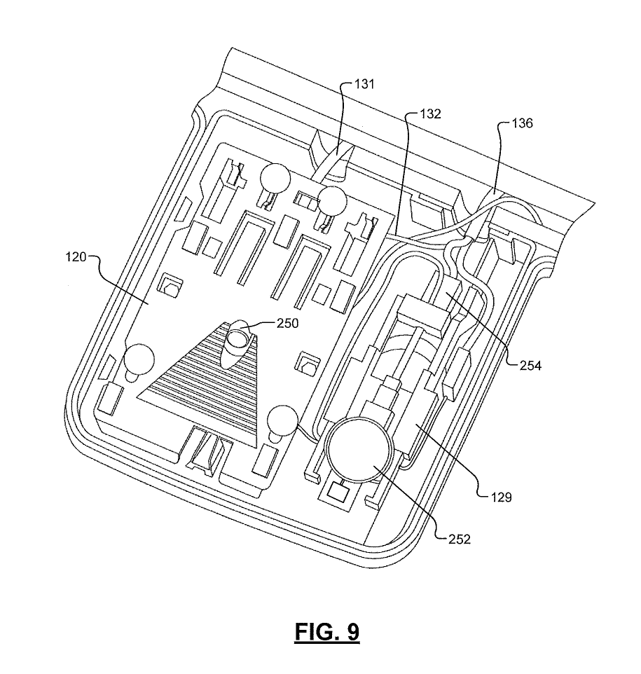

FIG. 9 shows a top view of an interior of the sensor farm assembly 100 of FIG. 2. The sensor farm assembly 100 includes the FCA camera bracket 120 and the ladder bracket 129. The FCA camera 250 is mounted on the FCA camera bracket 120. A humidity/rain sensor 252 is mounted on the ladder bracket 129. The FCA camera 250 and the humidity/rain sensor 252 are examples of the FCA camera 34 and the humidity/rain sensor 36 of FIG. 1. The electrical lines 131, 132, 134, 136 are shown. A first mirror connector 254 is shown, which supplies power to the rearview mirror assembly 102 and data to and from the rearview mirror assembly 102.

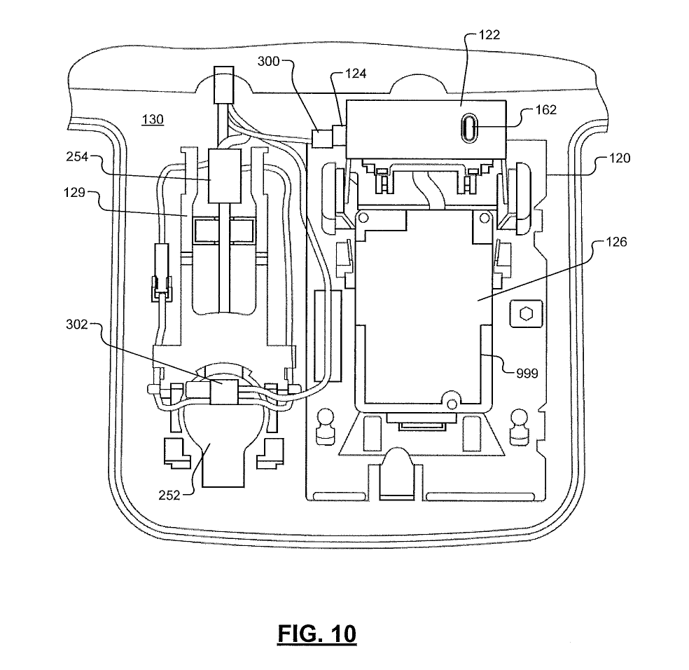

FIG. 10 shows a bottom view of the interior of the sensor farm assembly 100 of FIG. 2. The sensor farm assembly 100 includes the FCA camera bracket 120 and the ladder bracket 129, which are mounted on the glass mounting plate 130. The FCA camera housing 126 is mounted on the FCA camera bracket 120. A humidity/rain sensor 252 is mounted on the ladder bracket 129. The USB bracket 122 is connected to the FCA camera bracket 120. A USB module connector 300 is shown connecting to the USB receiving module 124. The first mirror connector 254 and a second mirror connector 302 are shown, which supplies power to the rearview mirror assembly 102 and data to and from the rearview mirror assembly 102.

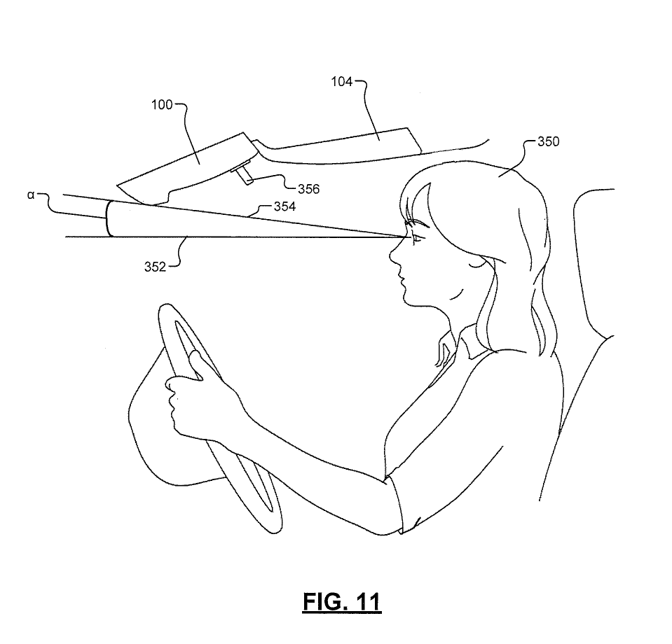

FIG. 11 shows an interior of a vehicle illustrating a vision interference requirement. Federal motor vehicle safety standards (FMVSS) and regulations requirements state that no object is to be within certain viewing areas. For example, FMVSS 305 states that no object can exist within a predetermined angle α (e.g., 3°) of a horizontal plane extending from centers of eyes of a vehicle operator. To illustrate this range a vehicle operator 350 is shown along with a horizontal plane represented by line 352. Boundary line 354 is at an angle a from line 352. Thus, the sensor farm assembly 100 is located above the boundary line 354. The overhead console 104 is shown above the sensor farm assembly 100. A USB drive 356 is shown being plugged into the sensor farm assembly 100. The area (or zone) above the boundary line 354 may be further restricted to be within a predetermined lateral distance from a longitudinal plane extending along a longitudinal centerline of the vehicle, wherein the longitudinal centerline of the vehicle extends from the front of the vehicle to the rear of the vehicle. This lateral distance may be for example 150 millimeters (mm). Thus, the zone in which the sensor farm assembly resides may have a width of for example 300 mm. This further restricts possible locations of USB receiving modules.

FIG. 12 shows an example of an accessory device 370 being connected to the USB receiver 32 of the sensor farm assembly 12 via a cable 372. The sensor farm assembly 12 includes the USB bracket 22, the FCA camera bracket 24, and the ladder bracket 26. The USB bracket 22 supports the USB receiving module 30 that includes the USB intermediate processing module 31 and the USB receiver 32. The FCA camera bracket 24 supports the FCA camera 34. The ladder bracket 26 supports the humidity/rain sensor 36 and a rear view mirror assembly, which is connected to the ladder bracket 26 via a rearview mirror assembly connector 38.

The accessory device 370 includes an interface 374, an accessory control module 376 and a memory 378. The cable 372 includes a first (or USB) connector 380 and may include a second connector 382. In one embodiment, the second connector 382 is included and is a second USB connector that may be plugged into the interface 374. In another embodiment, the second connector 382 is of a different type than USB and is plugged into the interface 374. In yet another embodiment, the second connector 382 is not included and the cable 372 is directly hard wired to the interface 374, such that wires of the cable 372 are directly connected to, for example a PCB of the accessory device 370.

The USB intermediate processing module 31 may supply power to the accessary device 370 via the USB receiver 32 and the cable 372. The USB intermediate processing module 31 may also receive data from and/or transfer data to the accessory device 370 via the USB receiver 32 and the cable 372.

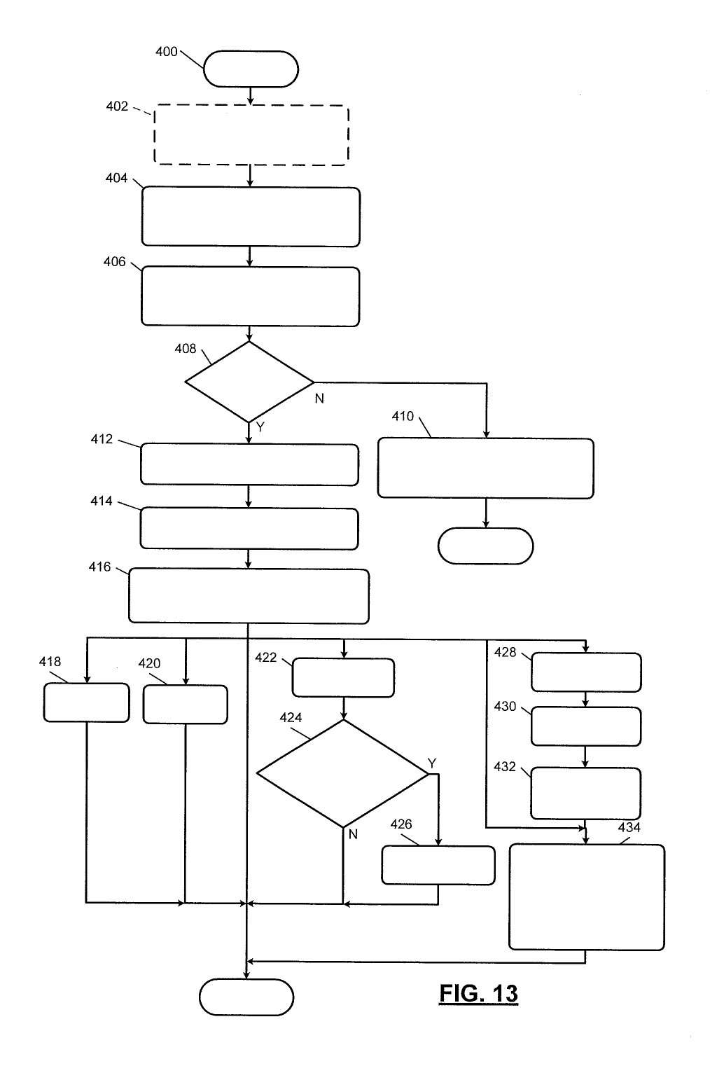

FIG. 13 shows an example USB method. Although the following operations are primarily described with respect to the implementation of FIG. 1, the operations may be modified to apply to other implementations of the present disclosure including the implementations of FIGS. 2-10 and 12. The operations may be iteratively performed. The method may begin at 400. At 402, the USB receiving module 30 and/or other control module of the vehicle system 10 may detect that the accessory device 14 is connected to the USB receiver 32. This may be a direct connection or may be via a cable, as described above. In one embodiment, operation 402 is not performed and operation 404 is a first operation performed. If operation 402 is performed, the following operations may be performed in response to detecting the accessory device 14.

At 404, the USB receiving module 30 supplies power to the accessory device 14. At 406, the USB receiving module 30 and/or other control module of the vehicle system 10 may attempt to establish a connection with the accessory device 14 and initiate an authorization process.

At 408, the USB receiving module 30 and/or other control module of the vehicle system 10 verifies that the accessory device 14 is an authorized device. Different accessory devices may have different authorization levels. For example, authorization levels of accessory devices of a vehicle operator, a vehicle owner, and an authorized technician may be different. The authorization level of the vehicle owner may be higher than the vehicle operator to maintain vehicle owner preferred settings in the vehicle. The authorization level of an authorized technician may be higher and/or different than a vehicle owner to allow the technician to check parameters, states of vehicle systems, perform certain diagnostic tests, update software and/or vehicle settings, etc. The USB receiver 32 may be used as an onboard diagnostic port allowing data to be downloaded to the accessory device 14, analyzed by an offboard system, and updates and/or changes performed as described below. The diagnostic permissions of the vehicle owner may be limited to certain features and not permit the vehicle owner to access and/or change certain data and/or software and/or perform certain tests permitted for the authorized technician.

During the authorization process, data may be exchanged between the USB intermediate processing module 31 and the accessory control module 46, such as passwords and/or encrypted keys. If the accessory device 14 is not authorized to connect to the vehicle systems, operation 410 is performed and the accessory device 14 is simply provided power. The accessory device 14 may be blocked by the user receiving module 30 and/or other control module of the vehicle system 10 from accessing the vehicle systems, modules, devices, memory, etc. Data transfer to the accessory device 14 may be prevented and/or data transfer from the accessory device 14 may be blocked. The user receiving module 30 may signal the body control module 58 to generate an alert and/or display an indicator indicating that the accessory device is an unauthorized device. The indication may be provided on a display, a dashboard, etc. In one embodiment, an indicator light in the sensor farm assembly is illuminated a first color.

At 412, the USB intermediate processing module 31 and/or other control module of the vehicle system 10 may generate a signal indicating the accessory device is connected and/or is authorized. The indication may be provided on a display, a dashboard, etc. In one embodiment, an indicator light in the sensor farm assembly is illuminated a second color different than the first color.

At 414, the USB intermediate processing module 31 receives an upload/download request from the accessory device 14 and/or from one of the control modules 50, 52, 54, 56, 58. An upload/download request may be initiated by a vehicle operator, vehicle owner, and/or technician via, for example, a user interface in the vehicle. At 416, data is transferred between at least the USB intermediate processing module 31 and the accessory control module 46. This may include transferring audio data, video data, images, vehicle parameters, vehicle status indication values, vehicle settings, updated software, updated settings and/or parameters, diagnostic software, diagnostic test data, diagnostic instructions, etc. The images may be images captured by the accessory device 14.

At 418, the infotainment control system may play an audio or a video file uploaded from the accessory device 14. Subsequent to performing operation 418 the method may end at 440. At 420, the infotainment control system may display images uploaded from the accessory device 14. Subsequent to performing operation 418 the method may end at 440.

At 422, the body control module 58 or other control module of the vehicle system 10 may analyze data and/or images uploaded from the accessory device 14 and/or other collision avoidance data and/or images collected by other sensors and/or cameras (e.g., the sensors/cameras 90) to determine whether the vehicle is approaching an object, is likely to collide with the object, and/or a collision is imminent. At 424, the body control module 58 or other control module of the vehicle system 10 determines whether the vehicle is approaching an object and/or if a collision is highly probable and/or imminent. If one of these conditions is true, operation 426 is performed, otherwise the method may end at 440. At 426, the body control module 58 or other control module of the vehicle system 10 may perform a countermeasure. The countermeasure may include: generating an alert signal; changing operation of the engine 66, the transmission 68, and/or the electric motor(s) 70; and/or actuating brakes via the brake actuation system 92.

At 428, based on the data transferred at 416, one or more of the control modules 50, 52, 54, 56, 58 may perform a diagnostic test to generate diagnostic data. At 430, the diagnostic data resulting from the test performed is transferred to and/or accessed by the USB intermediate processing module 31 and downloaded to the accessory device 14.

At 432, the USB intermediate processing module 31 receives data from the accessory device 14. The USB intermediate processing module 31 may receive instructions based on the data received at 416, 432, the results of the diagnostic test, and/or the diagnostic data downloaded at 430. The instructions may include instructions to change vehicle settings, codes, status flags, etc.

At 434, the USB intermediate processing module 31 and/or one or more of the other control modules of the vehicle system 10 performs an update, ceases certain operations, and/or prevents and/or limits operation of certain components and/or systems based on the data transferred at 416 and/or based on data received at 432. For example, if a component of a vehicle system is faulty, operation of that component and/or corresponding system may be prevented. Signals may be generated by any one of the modules 31, 50, 52, 54, 56, 58 to indicate if a component and/or system are faulty and/or if maintenance ought to be performed on the component and/or system. This fault and maintenance information may be downloaded to the accessory device 14.

During operations 414, 416, 418, 420, 422, 424, 426, 428, 430, 432, 434, the accessory device may be unplugged and/or plugged into the USB receiver 32 one or more times. Each time the accessory device 14 is unplugged and then plugged back in to the USB receiver 32, operations 402, 404, 406, 408, 410, 412 may be repeated.

The above-described operations of FIGS. 9-12 are meant to be illustrative examples; the operations may be performed sequentially, synchronously, simultaneously, continuously, during overlapping time periods or in a different order depending upon the application. Also, any of the operations may not be performed or skipped depending on the implementation and/or sequence of events.

The above-described systems and methods include windshield mounted sensor farm assemblies that provide easy access for powering accessory devices. The implementations are aesthetically pleasing and convenient for vehicle operator usage. The implementations eliminate and/or prevent occurrences of dangling cables between a windshield and a vehicle operator and/or interference with a rearview mirror assembly and/or a field-of-view of the vehicle operator. The implementations eliminate a need for additional windshield mounts and/or modifications to a headliner or overhead console of a vehicle in order to power accessory devices mounted on a windshield. The implementations allow for us of a short (e.g., less than 1-2 feet) cable to connect an accessory device mounted on a windshield to a sensor farm assembly.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

1. A sensor farm assembly comprising:
a plate configured to be mounted to an interior side of a windshield of a vehicle;
a first bracket connected to the plate; and
a universal serial bus receiving module configured to be connected to the first bracket, wherein the universal serial bus receiving module comprises
a processing module configured to receive power from a power source, wherein the power source is separate from the sensor farm assembly; and
a universal serial bus receiver configured to receive a universal serial bus connector of (i) a universal serial bus cable, or (ii) an accessory device, wherein the universal serial bus receiver is configured as a port for plugin reception of the universal serial bus connector and provides power from the processing module either directly to the accessory device or via the universal serial bus cable.

2. The sensor farm assembly of claim 1, further comprising:
a connector configured to connect to a rearview mirror assembly; and
a second bracket configured to connect to the plate and support the connector,
wherein the universal serial bus receiving module is connected to the first bracket above the rearview mirror assembly.

3. The sensor farm assembly of claim 2, further comprising:
a sensor configured to be mounted on the second bracket; and
a third bracket configured to hold a camera.

4. The sensor farm assembly of claim 1, further comprising a cover configured to cover the plate, the first bracket and the universal serial bus receiving module, wherein:
the cover comprises an access opening;
the access opening is disposed in an upper right corner of the cover; and
the universal serial bus receiver is accessible through the access opening, such that the universial serial bus connecter is received through the access opening and is plugged into the universal serial bus receiver in the access opening.

5. The sensor farm assembly of claim 4, wherein the access opening is on a side of the cover facing a rear view mirror assembly.

6. The sensor farm assembly of claim 1, wherein the processing module is configured to transfer data between a control module of the vehicle and the accessory device via a controller area network bus.

7. The sensor farm assembly of claim 6, wherein the data includes at least one of audio data or video data.

8. The sensor farm assembly of claim 6, wherein the data comprises images captured by the accessory device.

9. The sensor farm assembly of claim 6, wherein the data comprises at least one of vehicle settings, parameters, or status indicators.

10. The sensor farm assembly of claim 6, wherein the data comprises diagnostic data.

11. A vehicle system comprising:
the sensor farm assembly of claim 1; and
the power source.

12. The vehicle system of claim 11, wherein the power source is disposed in a headliner or an overhead console of the vehicle.

13. The vehicle system of claim 11, further comprising the accessory device.

14. The vehicle system of claim 13, wherein the accessory device is at least one of a camera, an autonomous sensor, a radar sensor or a communication device.

15. The vehicle system of claim 13, wherein the accessory device is a flash drive.

16. A method of operating a vehicle system, wherein the vehicle system includes a sensor farm assembly configured to mount to an interior side of a windshield, wherein the sensor farm assembly comprises a universal serial bus receiving module, wherein the universal serial bus receiving module comprises a processing module and a universal serial bus receiver, and wherein the universal serial bus receiver is configured to receive a universal serial bus connector of (i) a universal serial bus cable, or (ii) an accessory device, wherein the universal serial bus receiver is configured as a port for plugin reception of the universal serial bus connector, the method comprising:
receiving power from a power source at the processing module of the universal serial bus receiving module via a control module of the vehicle and not via the universal serial bus connector, wherein the power source is separate from the sensor farm assembly;
supplying power from the processing module to the universal serial bus receiver; and
supplying power from the universal serial bus receiver to the accessory device via the universal serial bus connector, wherein power is supplied from the universal serial bus receiver either directly to the accessory device or indirectly via a universal serial bus cable to the accessory device, wherein the universal serial bus receiver is configured to connect to the universal serial bus cable or the accessory device.

17. The method of claim 16, further comprising:
determining whether the accessory device is an authorized device; and
blocking data transfer from the accessory device if the accessory device is not authorized.

18. The method of claim 16, further comprising:
determining an authorization level of the accessory device; and
based on the authorization level, permitting upload of diagnostic data from the accessory device to the universal serial bus receiving module and execution of a diagnostic test based on the diagnostic data.

19. The method of claim 16, further comprising uploading images from the accessory device to the processing module, wherein the images are of an environment outside the vehicle.

20. The method of claim 16, further comprising:
uploading data from the accessory device to the processing module;
analyzing the data and determining whether the vehicle is approaching an object; and
performing a countermeasure based on whether the vehicle is approaching the object.
